(19) United States
(12) Patent Application Publication
(10) Pub. No.: US 2025/0021212 A1
(43) Pub. Date: Jan. 16, 2025

(54) PAGE VIEW GENERATION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Shuai ZHANG, Beijing (CN); Fei ZHAO, Beijing (CN)

(21) Appl. No.: 18/713,507

(22) PCT Filed: Nov. 3, 2022
(86) PCT No.: PCT/CN2022/129442

§ 371 Date: May 24, 2024

(30) Foreign Application Priority Data
Nov. 26, 2021 (CN) 202111424227.5

(51) Int. Cl. G06F 3/0483; G06F 40/106; G06F 40/114

(52) U.S. Cl. CPC G06F 3/0483; G06F 40/106; G06F 40/114

(57) ABSTRACT

Embodiments of the present disclosure provide a page view generation method and apparatus, an electronic device, and a storage medium. The method includes: determining at least one work item and a page subview to be processed for the at least one work item; determining layout configuration information in the page subview to be processed, to obtain a page subview to be generated; determining a target page subview based on field configuration information corresponding to the page subview to be generated; and determining a target page view based on at least one target page subview.

### CROSS-REFERENCE TO RELATED APPLICATIONS

The present application claims priority to Chinese Patent Application No. 202111424227.5, filed with the China National Intellectual Property Administration on Nov. 26, 2021, which is incorporated herein by reference in its entirety.

### TECHNICAL FIELD

Embodiments of the present disclosure relate to the field of computer technologies, and for example, to a page view generation method and apparatus, an electronic device, and a storage medium.

### BACKGROUND ART

At present, when an enterprise conducts a business or project, in order to clarify specific content of a plurality of work items corresponding to the business or project, the enterprise usually stores related information of the work items in a specific database. On this basis, such information is presented to a user in the form of one or more records in the database.

However, the presentation of the related information of the work items to the user using the database is not intuitive enough, and also results in a storage space waste. For example, there are usually a plurality of columns in the database to comprehensively present related information of a work item to the user. In this case, even if the work item involves information in only one dimension, records corresponding the information may occupy storage space of all the columns. In addition, a table modification operation is cumbersome when related information of a work item is added to or modified in the database.

### SUMMARY OF THE INVENTION

Embodiments of the present disclosure provide a page view generation method and apparatus, an electronic device, and a storage medium, providing users with an intuitive and high-degree-of-freedom work item configuration approach.

According to a first aspect, an embodiment of the present disclosure provides a page view generation method. The method includes:
determining at least one work item and a page subview to be processed for the at least one work item;
determining layout configuration information in the page subview to be processed, to obtain a page subview to be generated;
determining a target page subview based on field configuration information corresponding to the page subview to be generated; and
determining a target page view based on at least one target page subview.

According to a second aspect, an embodiment of the present disclosure further provides a page view generation apparatus. The apparatus includes:
a page-subview-to-be-processed determination module configured to determine at least one work item and a page subview to be processed for the at least one work item;
a page-subview-to-be-generated determination module configured to determine layout configuration information in the page subview to be processed, to obtain a page subview to be generated;
a target page subview determination module configured to determine a target page subview based on field configuration information corresponding to the page subview to be generated; and
a target page view determination module configured to determine a target page view based on at least one target page subview.

According to a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the page view generation method described in any one of the embodiments of the present disclosure.

According to a fourth aspect, an embodiment of the present disclosure further provides a storage medium including computer-executable instructions, where the computer-executable instructions, when executed by a computer processor, are configured to perform the page view generation method described in any one of the embodiments of the present disclosure.

### BRIEF DESCRIPTION OF DRAWINGS

Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a page view generation method according to an embodiment of the present disclosure;

FIG. 2 is a schematic flowchart of a page view generation method according to another embodiment of the present disclosure;

FIG. 3 shows a configuration page for an example work item page view according to an embodiment of the present disclosure;

FIG. 4 shows a design architecture of a core data table corresponding to a target page view according to an embodiment of the present disclosure;

FIG. 5 is a block diagram of a structure of a page view generation apparatus according to an embodiment of the present disclosure; and

FIG. 6 is a schematic diagram of a structure of an electronic device according to an embodiment of the present disclosure.

### DETAILED DESCRIPTION OF THE INVENTION

It should be understood that the multiple steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

FIG. 1 is a schematic flowchart of a page view generation method according to an embodiment of the present disclosure. This embodiment is applicable to a case in which a corresponding page view is constructed for related information of a work item. The method may be performed by a page view generation apparatus. The apparatus may be implemented in the form of software and/or hardware, and the hardware may be an electronic device, such as a mobile terminal, a PC, or a server.

Before the technical solution is described, an exemplary description may be given to the application scenario. The technical solution may be applied in any scenario of constructing a corresponding page view based on work item-related requirements. For example, an enterprise wants to construct a work item for a business or project, and also wants to store related data information of the work item in a proper way to intuitively present the data information to a user. Based on the technical solution of this embodiment, a corresponding page view can be constructed, with a high degree of freedom, for the work item required by the project, and the related data information can also be flattened and stored, and intuitively presented.

As shown in FIG. 1, the method in this embodiment includes the following steps.

S110: Determine at least one work item and a page subview to be processed for the at least one work item.

The work item refers to all items that are planned or need to be tracked in a project; and may be understood as any entity collaborated on by multiple people. In addition, the work item is also a part that can be clearly identified or separated from the project. For example, the work item includes various types, such as a requirement-type work item, a task-type work item, and a defect-type work item. The requirement-type work item is a work item created in order to meet user requirements. For example, specific work content corresponding to the requirement-type work item may be “Send a reminder notification to a project administrator before a project approval process node is due”. The task-type work item is a work item created for various tasks that need to be completed during a project or requirement processing process. For example, specific work content corresponding to the task-type work item may be “Add two servers in a target equipment room”. The defect-type work item is a work item created for problems that occur in products or application services. For example, specific work content corresponding to the defect-type work item may be “A reminder notification message is sent to a project administrator twice before a project approval process node is due”.

In this embodiment, the work item may be determined in a pre-developed platform or system. It can be understood that a plurality of work item selection controls are pre-developed in the platform or system. When the platform or system starts to run, the work item required by the user can be determined by detecting a trigger operation on the controls. It should be noted that one or more work items may be determined, and the specific number of work items depends on actual requirements of the user. In addition, the specific implementation method of determining the work item is not limited to the form of detecting the trigger operation on the control in the above example, and is not specifically limited in the embodiments of the present disclosure.

In this embodiment, while the at least one work item is determined, the page subview to be processed that corresponds to the work item may be determined. The page subview to be processed refers to a page that reflects related information of the work item as a whole. It can be understood that a section for displaying elements, such as text, an image, and a hyperlink, may be pre-planned in the page subview to be processed that corresponds to each work item. In a platform or system for determining a work item, a mapping table representing association relationships between a plurality of work items and corresponding page subviews to be processed may be stored in advance. Based on this, when one or more work items are determined, the corresponding page subview to be processed can be presented in a specific page of the platform or system through a table lookup.

S120: Determine layout configuration information in the page subview to be processed, to obtain a page subview to be generated.

In this embodiment, after the at least one work item and the page subview to be processed that corresponds to the at least one work item are determined, the layout configuration information in the page subview to be processed can be determined. The layout configuration information is information, for example, one or more key fields, that determine a type of content in a plurality of sections in a final page view. It can be understood that the layout configuration information can at least reflect the division of a plurality of sections in the page subview to be processed, and is also a basis for the platform or system to perform the division of a plurality of sections.

For example, when the page subview to be processed for a work item is determined, it may be determined that the layout configuration information corresponding to the page subview to be processed includes “Basic information”, “Comment”, “Operation record”, and “Table”. That is, in a page view generated by the platform or system for this work item, an entire page is divided into a basic information display section, a comment display section, an operation record display section, and a table display section based on functions.

For example, after the layout configuration information is determined, the page subview to be generated that corresponds to the layout configuration information can be displayed in a specific page of a platform or system for generating a page view. Page subviews to be generated refer to a plurality of subviews combined to generate a work item page view, which can at least reflect information in a specific section in the page view.

Still using the above example for illustration, when it is determined that the layout configuration information includes “Basic information”, “Comment”, “Operation record”, and “Table”, information editing and setting pages corresponding to the four function dimensions can be separately displayed in the platform or system for generating a page view. For example, in the page subview to be generated that corresponds to Basic information, information, such as a name, an identifier, and a person in charge, of the work item can be edited and confirmed; and in the page subview to be generated that corresponds to Operation record, a recording rule and a display mode of Operation record can be set.

S130: Determine a target page subview based on field configuration information corresponding to the page subview to be generated.

In this embodiment, after a plurality of page subviews to be generated that correspond to the layout configuration information are determined, one or more parameters of information in an associated dimension may be set in the page subviews to be generated, so as to obtain field configuration information for the information in the dimension. The field configuration information can determine at least content and a mode of display in a specific section of information in a dimension in the layout configuration information. Therefore, after the field configuration information corresponding to the page subview to be generated is determined, the platform or system for generating a page view can obtain the corresponding target page subview.

Still using the above example for illustration, after the page subview to be generated that corresponds to “Basic information” is determined, the parameters, such as the name, the identifier, the person in charge, associated with the work item may be set, and corresponding three fields “Work item A”, “ID001”, and “User A” are then obtained as the field configuration information. After a confirm operation of the user is received, the platform or system can determine the target page subview corresponding to “Basic information”. It can be understood that in the target page subview, the above field configuration information is displayed based on a preset display mode (such as a specific text display format and layout mode).

It should be noted that for the page subview to be generated that corresponds to information in a specific function dimension, after the corresponding field configuration information is set in the page subview to be generated, the platform or system can also store specific field configuration content which can be directly invoked during subsequent processes of generating page views for other work items, which improves the efficiency of page view generation and the user experience.

S140: Determine a target page view based on at least one target page subview.

In this embodiment, when the target page subview of the work item is determined, it indicates that the platform or system has determined the display content of each section in the page view corresponding to the work item. For example, the target page view can be constructed by invoking or splicing the at least one target page subview. It can be understood that the target page view is a page view finally generated by the platform or system and corresponding to the work item. Based on the specific content corresponding to the specific function dimension displayed in at least one section, the related information of the work item can be comprehensively reflected.

Still using the above example for illustration, when four target page subviews corresponding to “Basic information”, “Comment”, “Operation record”, and “Table” are determined, the platform or system can use a preset blank page template to invoke the four target page subviews, and then display the specific content of Basic information, of Comment, of Operation record, and of Table in four different sections, respectively, so as to obtain the target page view that comprehensively reflects the related information of the work item.

In this embodiment, the process of determining the layout configuration information of the at least one page subview to be processed for the work item and the field configuration information of the page subview to be generated can essentially be understood as a process of building a digital work item model. After the work item model is built, by combining and invoking or splicing the at least one target page subview, a web user interface (Web UI) for information recording and presentation can be obtained.

In the technical solution of this embodiment, the at least one work item and the page subview to be processed for the at least one work item are first determined, that is, work items that need to be presented, and the entire page to be processed that corresponds to each work item are clarified. Then, the layout configuration information in each page subview to be processed is determined to obtain the page subview to be generated, and the target page subview is then determined based on the field configuration information corresponding to each page subview to be generated. The entire page is divided based on a work item model, and a plurality of partial views obtained through division are constructed separately. The target page view is determined based on the target page subview. Using the page view as an object carrying the related information of the work item provides users with an intuitive and high-degree-of-freedom work item configuration approach, avoiding the problems of occupancy of a large storage space and a cumbersome table modification operation caused by using a database to store work item information.

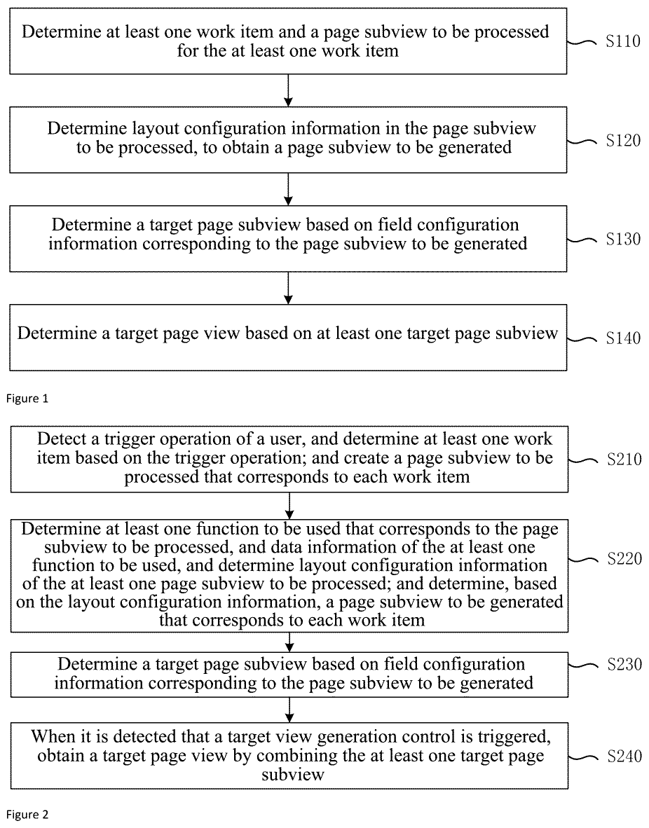

FIG. 2 is a schematic flowchart of a page view generation method according to another embodiment of the present disclosure. On the basis of the foregoing embodiment, the work item is determined based on a trigger operation of a user, and the corresponding page subview to be processed is determined, for example, a function to be used of the page subview to be processed is determined, so as to determine the corresponding layout configuration information; the page subview to be generated of each work item is determined based on the layout configuration information; the target page subview is determined based on the field configuration information in the page subview to be generated; and a plurality of target page subviews are combined to obtain the target page view. The related information of the work item can be set with a high degree of freedom. In addition, some field attributes are redundant in the field configuration information, which improves the efficiency of data query in the target page view. For its example implementation, reference can be made to the technical solution of this embodiment. The technical terms that are the same as or corresponding to the above embodiment will not be described here again.

As shown in FIG. 2, the method includes the following steps.

S210: Detect a trigger operation of a user, and determine at least one work item based on the trigger operation; and create a page subview to be processed that corresponds to each work item.

In this embodiment, the platform or system for generating a work item page view can at least detect and respond to the trigger operation of the user. For example, when the trigger operation of the user is detected, at least one work item that meets the current requirements of the user can be determined, and the page subview to be processed that corresponds to each work item can then be created in a specific page.

During an actual application process, determining the page subview to be processed that corresponds to each work item can be implemented by invoking a PageView component in a page view development tool. The PageView refers to a page view container. After the platform or system determines the at least one work item, the container can be associated with at least the corresponding work item, and then construct a corresponding page view for the work item. This is be described below with reference to FIG. 3.

Refer to FIG. 3. After the user determines the work item “Details page layout” in the platform or system for generating a page view according to actual requirements, the platform can create the corresponding PageView and display it in a particular page (i.e., a page below Details page layout in FIG. 3). It can be understood that the PageView created by the platform for “Details page layout” is the corresponding page subview to be processed. In addition, for the other three work items “Process rule”, “Table page layout”, and “Process role”, the platform can also create corresponding page subviews to be processed, respectively, which will not be described again in the embodiments of the present disclosure.

S220: Determine at least one function to be used that corresponds to the page subview to be processed, and data information of the at least one function to be used, and determine layout configuration information of each page subview to be processed; and determine, based on the layout configuration information, a page subview to be generated that corresponds to each work item.

In this embodiment, after determining the page subview to be processed that corresponds to the work item, the platform or system can also determine the function to be used of the page subview to be processed, and the data information of the at least one function to be used, and then determine, based on the information, the layout configuration information of the page subview to be processed.

Still refer to FIG. 3. After the page subview to be processed that corresponds to the work item “Details page layout” is determined, the function to be used of the subview can be determined. That is, when presentation content and a presentation mode of a project details page are set based on Details page layout, it can be determined that the specific functions involved include basic information setting, node details setting, comment/remark setting, operation record setting, defect management setting, etc. When selecting a function to be used in any dimension, the user can set the specific parameters involved in the function. It can be understood that the determined function to be used involves a plurality of dimensions, the specific parameter set for the function to be used in each dimension is the data information of the function, and the collection of the data information is the layout configuration information of the page subview to be processed.

During an actual application process, the data information corresponding to the function to be used can be represented by a PageSection. It can be understood that the PageSection, as a member of the PageView, can carry at least data information reflecting the functions to be used. That is, the PageView is constructed based on one or more PageSections, and a particular function can be implemented by processing or invoking content in one PageSection. In addition, based on the data information in the PageSection, the layout configuration information for reflecting the division of specific sections in the page subview to be processed can also be determined.

For example, after the layout configuration information of the page subview to be processed is determined, for example, based on the layout configuration information, a corresponding page view to be processed is divided into a plurality of function display sections based on display size information of the plurality of function display sections in the current layout configuration information, to determine the page subview to be generated.

In this embodiment, in order to determine display sections of a plurality of work items in the target page view, after the layout configuration information of the page subview to be processed is determined, the display size information of the plurality of function sections can also be determined based on the information. The display size information may include coordinates and sizes of space sections occupied by the related information in the page view to be processed. For example, after the layout configuration information (i.e. Basic information, Node details, Comment/Remark, etc.) of “Details page layout” is determined, associated information of the functions such as Basic information, Node details, and Comment/Remark, and the coordinates and sizes of the space sections occupied by the associated information in the page view of Details page layout can be determined.

In addition, in order to adapt the space in the page view to be processed to a section occupied by associated information of the at least one function to be used, the page view to be processed further needs to be divided in advance based on the display size information, to determine the page subview to be generated. Still using the above example for illustration, based on the coordinates and sizes of the space sections occupied by the associated information of the functions such as Basic information, Node details, and Comment/Remark in the page view to be processed, division is performed in advance in the page subviews to be processed that correspond to Details page layout, so that when the page view of Details page layout is finally displayed, the associated information of the functions such as Basic information, Node details, and Comment/Remark are invoked.

S230: Determine a target page subview based on field configuration information corresponding to the page subview to be generated.

For example, after the page subview to be generated is determined, for each function display section in the page subview to be generated, at least one target field configured for a current function display section is received, and field display parameter information of the target field in the current function display section is determined; the field configuration information is determined based on the at least one target field and the corresponding field display parameter information; and the at least one target field is displayed in the current function display section based on the field display parameter in the field configuration information, to obtain the target page subview. This process will be exemplified below with reference to FIG. 3.

Refer to FIG. 3. When the platform or system for generating a page view determines the work item Details page layout and determines the page subview to be generated that corresponds to the function to be used “Basic information” thereof, the specific parameters in the function display section of “Basic information” can be determined based on input information of the user, including a task name, a task type, a planning iteration, a update person, a role and module, a requirement follower, a task description, etc. It can be understood that the above specific parameters are the target fields associated with the function display section of “Basic information”. In addition, in the platform or system for generating a page view, the user can perform operations such as adding, deleting, and modifying the target fields according to actual requirements.

Still refer to FIG. 3. After the target field configured by the user for the current function display section is received, it is also required to determine the field display parameter information of the target field in the section. It can be understood that the field display parameter information is actual data assigned by the user to the target field, such as a specific parameter value, text, or a link. For example, after the target fields and the corresponding field display parameter information are all configured, the field configuration information corresponding to the function to be used is obtained. It can be understood that the field configuration information is information that relies on specific parameters to reflect work content involved in the function to be used.

Still refer to FIG. 3. After the field configuration information corresponding to the function to be used is determined, the target page subview corresponding to the work item “Details page layout” can be obtained. It can be understood that in the obtained page subview of Details page layout, the specific task name, task type, planning iteration, update person, role and module, requirement follower and task description will be presented in a particular layout plan. For example, in the target page subview, the specific information of the above parameters is presented in a top-to-bottom layout manner.

During an actual application process, the above field configuration information can be represented by a PageItem. As the smallest unit in the page view, the PageItems can correspond to a plurality of fields on a one-to-one basis. Each field is composed of basic information such as a field flag, a field name, a field type, and a field configuration, and some supplementary information indicating advanced attributes. For example, instances of stored fields are represented by fields, and field types include multiline text types, numeric types, option types, time and date types, person types, basic data types, rich text, associated work items, etc. Based on this, the PageItem can be understood as a specific instance of the field on the configuration side. It should be noted that during an actual application process, some field attributes can be redundant in the PageItem, thereby improving data query efficiency.

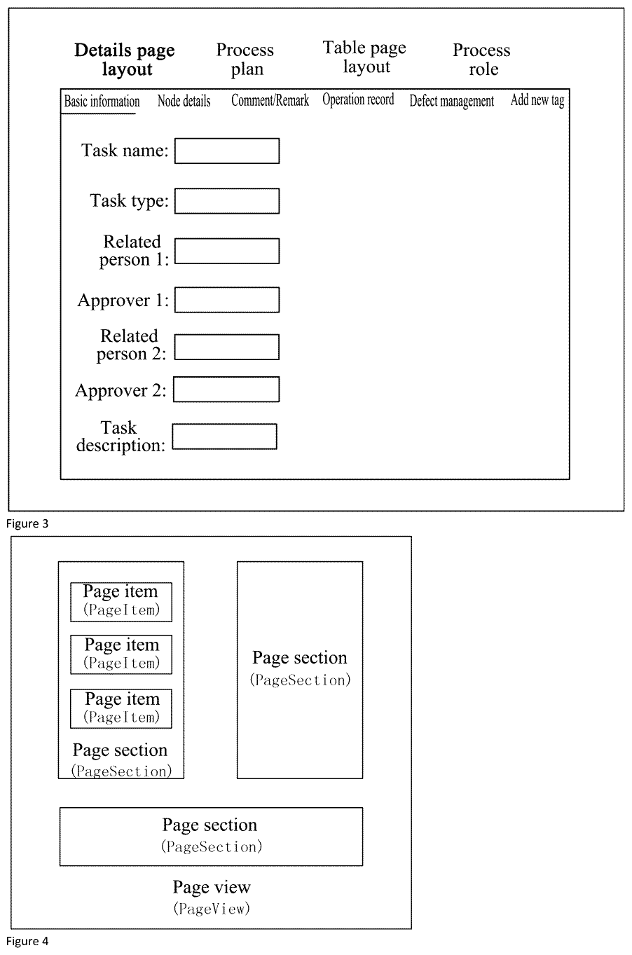

Here, in combination with a logical relationship among the PageView, the PageSection, and the PageItem in FIG. 4, it can be seen that the PageView is composed of at least one PageSection, the PageSection is obtained through division for the entire page layout based on the functions and is composed of at least one PageItem, and the PageItem is the smallest unit in the page view composition.

S240: When it is detected that a target view generation control is triggered, obtain a target page view by combining the at least one target page subview.

In this embodiment, in the platform or system for generating a work item page view, a control for generating a target view may be pre-developed. After the user triggers the control, the platform can generate the target page view. It can be understood that for this control, the trigger operation of the user will be detected only after the at least one work item and the target page subview corresponding to the work item are both determined (that is, there is a data basis for generating the target page view).

For example, when it is detected that the target view generation control is triggered, the at least one target page subview can be combined to obtain the target page view required by the user. Using the plurality of work items in FIG. 3 as an example, when the target page subviews corresponding to Basic information, Node details, Comment/Remark, Operation record, and Defect management are determined, if it is detected that the user triggers the target view generation control, the above five target page subviews are combined to obtain the target page view corresponding to Details page layout. It can be understood that in the target page view, specific information involved in Basic information, Node details, Comment/Remark, Operation record, and Defect management can be displayed in specific sections based on the layout configuration information.

In the technical solution of this embodiment, the work item is determined based on the trigger operation of the user, and the corresponding page subview to be processed is determined, for example, the function to be used of the page subview to be processed is determined, so as to determine the corresponding layout configuration information; the page subview to be generated of the at least one work item is determined based on the layout configuration information; the target page subview is determined based on the field configuration information in the page subview to be generated; and a plurality of target page subviews are combined to obtain the target page view. The related information of the work item can be set with a high degree of freedom. In addition, some field attributes are redundant in the field configuration information, which improves the efficiency of data query in the target page view.

FIG. 5 is a block diagram of a structure of a page view generation apparatus according to an embodiment of the present disclosure. The apparatus can perform the page view generation method provided in any one of the embodiments of the present disclosure, and has corresponding functional modules and beneficial effects for performing the method. As shown in FIG. 5, the apparatus includes: a page-subview-to-be-processed determination module 310, a page-subview-to-be-generated determination module 320, a target page subview determination module 330, and a target page view determination module 340.

The page-subview-to-be-processed determination module 310 is configured to determine at least one work item and a page subview to be processed for the at least one work item.

The page-subview-to-be-generated determination module 320 is configured to determine layout configuration information in the page subview to be processed, to obtain a page subview to be generated.

The target page subview determination module 330 is configured to determine a target page subview based on field configuration information corresponding to the page subview to be generated.

The target page view determination module 340 is configured to determine a target page view based on at least one target page subview.

On the basis of the above plurality of technical solutions, the page-subview-to-be-processed determination module 310 includes a work item determination unit and a page-subview-to-be-processed determination unit.

The work item determination unit is configured to detect a trigger operation of a user, and determine the at least one work item based on the trigger operation.

The page-subview-to-be-processed determination unit is configured to create a page subview to be processed that corresponds to each work item.

On the basis of the above plurality of technical solutions, the page-subview-to-be-generated determination module 320 includes a layout configuration information determination unit and a page-subview-to-be-generated determination unit.

The layout configuration information determination unit is configured to determine at least one function to be used that corresponds to the page subview to be processed, and data information of the at least one function to be used, and determine the layout configuration information of the at least one page subview to be processed.

The page-subview-to-be-generated determination unit is configured to determine, based on the layout configuration information, the page subview to be generated that corresponds to each work item.

For example, the page-subview-to-be-generated determination unit is further configured to: based on the layout configuration information, divide a corresponding page view to be processed into a plurality of function display sections based on display size information of the plurality of function display sections in the current layout configuration information, to determine the page subview to be generated.

On the basis of the above plurality of technical solutions, the target page subview determination module 330 includes a field display parameter information determination unit, a field configuration information determination unit, and a target page subview determination unit.

The field display parameter information determination unit is configured to: for each function display section in the page subview to be generated, receive at least one target field configured for a current function display section, and determine field display parameter information of the target field in the current function display section.

The field configuration information determination unit is configured to determine the field configuration information based on the at least one target field and the corresponding field display parameter information.

The target page subview determination unit is configured to display the at least one target field in the current function display section based on the field display parameter in the field configuration information, to obtain the target page subview.

For example, the target page view determination module 340 is further configured to: when it is detected that a target view generation control is triggered, obtain the target page view by combining the at least one target page subview.

In the technical solution provided in this embodiment, the at least one work item and the page subview to be processed for the at least one work item are first determined, that is, work items that need to be presented, and the entire page to be processed that corresponds to the at least one work item are clarified. Then, the layout configuration information in the page subview to be processed is determined to obtain the page subview to be generated, and the target page subview is then determined based on the field configuration information corresponding to the page subview to be generated. The entire page is divided based on a work item model, and each partial view obtained through division is constructed; and The target page view is determined based on the target page subview. Using the page view as an object carrying the related information of the work item provides users with an intuitive and high-degree-of-freedom work item configuration approach, avoiding the problems of occupancy of a large storage space and a cumbersome table modification operation caused by using a database to store work item information.

The page view generation apparatus provided in this embodiment of the present disclosure can perform the page view generation method provided in any one of the embodiments of the present disclosure, and has corresponding functional modules and beneficial effects for performing the method.

It is worth noting that the plurality of units and modules included in the above apparatus are obtained through division merely according to functional logic, but are not limited to the above division, as long as corresponding functions can be implemented. In addition, the specific names of the plurality of functional units are merely used for mutual distinguishing, and are not intended to limit the protection scope of the embodiments of the present disclosure.

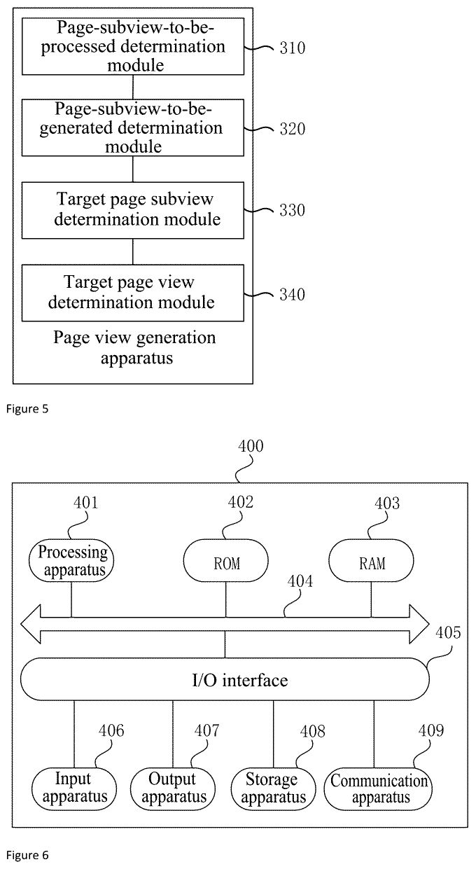

FIG. 6 is a schematic diagram of a structure of an electronic device according to an embodiment of the present disclosure. Reference is made to FIG. 6 below, which is a schematic diagram of a structure of an electronic device (such as a terminal device or a server in FIG. 6) 400 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 400 may include a processing apparatus (e.g., a central processor, a graphics processor, etc.) 401 that may perform multiple appropriate actions and processing in accordance with a program stored in a read-only memory (ROM) 402 or a program loaded from a storage apparatus 406 into a random access memory (RAM) 403. The RAM 403 further stores various programs and data required for the operation of the electronic device 400. The processing apparatus 401, the ROM 402, and the RAM 403 are connected to each other through a bus 404. An input/output (I/O) interface 405 is also connected to the bus 404.

Generally, the following apparatuses may be connected to the I/O interface 405: an input apparatus 406 including, for example, a touchscreen, a touch panel, a keyboard, a mouse, a camera, a microphone, an accelerometer, a gyroscope, etc.; an output apparatus 407 including, for example, a liquid crystal display (LCD), a speaker, and a vibrator; the storage apparatus 406 including, for example, a tape and a hard disk; and a communication apparatus 409. The communication apparatus 409 may allow the electronic device 400 to perform wireless or wired communication with other devices to exchange data. Although FIG. 6 shows the electronic device 500 having multiple apparatuses, it should be understood that it is not required to implement or have all of the shown apparatuses. It may be an alternative to implement or have more or fewer apparatuses.

In particular, according to an embodiment of the present disclosure, the processes described above with reference to the flowcharts may be implemented as a computer software program. For example, this embodiment of the present disclosure includes a computer program product, which includes a computer program carried on a non-transitory computer-readable medium, where the computer program includes program code for performing the methods shown in the flowcharts. In such an embodiment, the computer program may be downloaded from a network through the communication apparatus 409 and installed, installed from the storage apparatus 406, or installed from the ROM 402. When the computer program is executed by the processing apparatus 401, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device provided in this embodiment of the present disclosure and the page view generation method provided in the above embodiment belong to the same inventive concept. For the technical details not described in detail in this embodiment, reference can be made to the above embodiment, and this embodiment and the above embodiment have the same beneficial effects.

An embodiment of the present disclosure provides a computer storage medium storing a computer program thereon, where when executed by a processor, the program implements the page view generation method provided in the above embodiment.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as a HyperText Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
determine at least one work item and a page subview to be processed for the at least one work item;
determine layout configuration information in the page subview to be processed, to obtain a page subview to be generated;
determine a target page subview based on field configuration information corresponding to the page subview to be generated; and determine a target page view based on at least one target page subview.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the accompanying drawings illustrate the possibly implemented architecture, functions, and operations of the system, method, and computer program product according to multiple embodiments of the present disclosure. In this regard, each block in the flowcharts or the block diagrams may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagrams and/or the flowcharts, and a combination of the blocks in the block diagrams and/or the flowcharts may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, [Example 1] provides a page view generation method, including:
determining at least one work item and a page subview to be processed for the at least one work item;
determining layout configuration information in the page subview to be processed, to obtain a page subview to be generated;
determining a target page subview based on field configuration information corresponding to the page subview to be generated; and determining a target page view based on at least one target page subview.

According to one or more embodiments of the present disclosure, [Example 2] provides a page view generation method, further including:
for example, detecting a trigger operation of a user, and determining the at least one work item based on the trigger operation; and
creating a page subview to be processed that corresponds to each work item.

According to one or more embodiments of the present disclosure, [Example 3] provides a page view generation method, further including:
for example, determining at least one function to be used that corresponds to the page subview to be processed, and data information of the at least one function to be used, and determining the layout configuration information of the at least one page subview to be processed; and
determining, based on the layout configuration information, the page subview to be generated that corresponds to each work item.

According to one or more embodiments of the present disclosure, [Example 4] provides a page view generation method, further including:
for example, based on the layout configuration information, dividing a corresponding page view to be processed into a plurality of function display sections based on display size information of the plurality of function display sections in the current layout configuration information, to determine the page subview to be generated.

According to one or more embodiments of the present disclosure, [Example 5] provides a page view generation method, further including:
for example, for each function display section in the page subview to be generated, receiving at least one target field configured for a current function display section, and determining field display parameter information of the target field in the current function display section; determining the field configuration information based on the at least one target field and the corresponding field display parameter information; and
displaying the at least one target field in the current function display section based on the field display parameter in the field configuration information, to obtain the target page subview.

According to one or more embodiments of the present disclosure, [Example 6] provides a page view generation method, further including:
for example, when it is detected that a target view generation control is triggered, obtaining the target page view by combining the at least one target page subview.

According to one or more embodiments of the present disclosure, [Example 7] provides a page view generation apparatus, including:
a page-subview-to-be-processed determination module configured to determine at least one work item and a page subview to be processed for the at least one work item;
a page-subview-to-be-generated determination module configured to determine layout configuration information in the page subview to be processed, to obtain a page subview to be generated;
a target page subview determination module configured to determine a target page subview based on field configuration information corresponding to the page subview to be generated; and
a target page view determination module configured to determine a target page view based on at least one target page subview.

According to one or more embodiments of the present disclosure, [Example 8] provides a page view generation apparatus.

For example, the page-subview-to-be-processed determination module includes a work item determination unit and a page-subview-to-be-processed determination unit, where the work item determination unit is configured to detect a trigger operation of a user, and determine the at least one work item based on the trigger operation; and the page-subview-to-be-processed determination unit is configured to create a page subview to be processed that corresponds to each work item.

Furthermore, although multiple operations are depicted in a particular order, it should not be understood as requiring that these operations be performed in the particular order shown or in sequential order. Under specific circumstances, multitasking and parallel processing may be advantageous. Similarly, although several specific implementation details are included in the above discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

1. A page view generation method, comprising:
determining at least one work item and a page subview to be processed for the at least one work item;
determining layout configuration information in the page subview to be processed, to obtain a page subview to be generated;
determining a target page subview based on field configuration information corresponding to the page subview to be generated; and
determining a target page view based on at least one target page subview.

2. The method according to claim 1, wherein the determining at least one work item and a page subview to be processed for the at least one work item comprises:
detecting a trigger operation of a user, and determining the at least one work item based on the trigger operation; and
creating a page subview to be processed that corresponds to each work item.

3. The method according to claim 1, wherein the determining layout configuration information in the page subview to be processed, to obtain a page subview to be generated comprises:
determining at least one function to be used that corresponds to the page subview to be processed, and data information of the at least one function to be used, and determining the layout configuration information of the at least one page subview to be processed; and
determining, based on the layout configuration information, a page subview to be generated that corresponds to each work item.

4. The method according to claim 3, wherein the determining, based on the layout configuration information, a page subview to be generated that corresponds to each work item comprises:
dividing a corresponding page view to be processed into a plurality of function display sections based on display size information of the plurality of function display sections in the layout configuration information, to determine the page subview to be generated.

5. The method according to claim 4, wherein the determining a target page subview based on field configuration information corresponding to the page subview to be generated comprises:
for each function display section in the page subview to be generated, receiving at least one target field configured for a current function display section, and determining field display parameter information of the target field in the current function display section;
determining the field configuration information based on the at least one target field and the corresponding field display parameter information; and
displaying the at least one target field in the current function display section based on the field display parameter in the field configuration information, to obtain the target page subview.

6. The method according to claim 1, wherein the determining a target page view based on at least one target page subview comprises:
in response to detecting that a target view generation control is triggered, obtaining the target page view by combining the at least one target page subview.

7. (canceled)

8. (canceled)

9. An electronic device, comprising:
one or more processors; and
a storage apparatus configured to store one or more programs, wherein
the one or more programs, when executed by the one or more processors, cause the one or more processors to:
determine at least one work item and a page subview to be processed for the at least one work item;
determine layout configuration information in the page subview to be processed, to obtain a page subview to be generated;
determine a target page subview based on field configuration information corresponding to the page subview to be generated; and
determine a target page view based on at least one target page subview.

10. A non-transitory storage medium comprising computer-executable instructions, wherein the computer-executable instructions, when executed by a computer processor, are configured to perform
determining at least one work item and a page subview to be processed for the at least one work item;
determining layout configuration information in the page subview to be processed, to obtain a page subview to be generated;
determining a target page subview based on field configuration information corresponding to the page subview to be generated; and
determining a target page view based on at least one target page subview.

11. The electronic device according to claim 9, wherein the one or more processors are caused to determine at least one work item and a page subview to be processed for the at least one work item by being caused to:
detect a trigger operation of a user, and determine the at least one work item based on the trigger operation; and
create a page subview to be processed that corresponds to each work item.

12. The electronic device according to claim 9, wherein the one or more processors are caused to determine layout configuration information in the page subview to be processed, to obtain a page subview to be generated by being caused to:
determine at least one function to be used that corresponds to the page subview to be processed, and data information of the at least one function to be used, and determine the layout configuration information of the at least one page subview to be processed; and
determine, based on the layout configuration information, a page subview to be generated that corresponds to each work item.

13. The electronic device according to claim 12, wherein the one or more processors are caused to determine, based on the layout configuration information, a page subview to be generated that corresponds to each work item by being caused to:
divide a corresponding page view to be processed into a plurality of function display sections based on display size information of the plurality of function display sections in the layout configuration information, to determine the page subview to be generated.

14. The electronic device according to claim 13, wherein the one or more processors are caused to determine a target page subview based on field configuration information corresponding to the page subview to be generated by being caused to:
for each function display section in the page subview to be generated, receive at least one target field configured for a current function display section, and determine field display parameter information of the target field in the current function display section;
determine the field configuration information based on the at least one target field and the corresponding field display parameter information; and
display the at least one target field in the current function display section based on the field display parameter in the field configuration information, to obtain the target page subview.

15. The electronic device according to claim 9, wherein the one or more processors are caused to determine a target page view based on at least one target page subview by being caused to:
in response to detecting that a target view generation control is triggered, obtain the target page view by combining the at least one target page subview.

16. The non-transitory storage medium according to claim 10, wherein the determining at least one work item and a page subview to be processed for the at least one work item comprises:
detecting a trigger operation of a user, and determining the at least one work item based on the trigger operation; and
creating a page subview to be processed that corresponds to each work item.

17. The non-transitory storage medium according to claim 10, wherein the determining layout configuration information in the page subview to be processed, to obtain a page subview to be generated comprises:
determining at least one function to be used that corresponds to the page subview to be processed, and data information of the at least one function to be used, and determining the layout configuration information of the at least one page subview to be processed; and
determining, based on the layout configuration information, a page subview to be generated that corresponds to each work item.

18. The non-transitory storage medium according to claim 17, wherein the determining, based on the layout configuration information, a page subview to be generated that corresponds to each work item comprises:
dividing a corresponding page view to be processed into a plurality of function display sections based on display size information of the plurality of function display sections in the layout configuration information, to determine the page subview to be generated.

19. The non-transitory storage medium according to claim 18, wherein the determining a target page subview based on field configuration information corresponding to the page subview to be generated comprises:
for each function display section in the page subview to be generated, receiving at least one target field configured for a current function display section, and determining field display parameter information of the target field in the current function display section;
determining the field configuration information based on the at least one target field and the corresponding field display parameter information; and
displaying the at least one target field in the current function display section based on the field display parameter in the field configuration information, to obtain the target page subview.

20. The non-transitory storage medium according to claim 10, wherein the determining a target page view based on at least one target page subview comprises:
in response to detecting that a target view generation control is triggered, obtaining the target page view by combining the at least one target page subview.
